(19) United States
(12) Patent Application Publication
(10) Pub. No.: US 2017/0032641 A1
(43) Pub. Date: Feb. 2, 2017

(54) WIRELESS MOTION DETECTING DEVICE AND SYSTEM THEREOF

(71) Applicant: UNITED INTEGRATED SERVICES CO., LTD., Taipei City (TW)

(72) Inventors: HUNG-HSIANG HUANG, Taipei City (TW); CHUNHSIUNG WANG, New Taipei City (TW); CHAO-SHUI CHEN, New Taipei City (TW)

(21) Appl. No.: 15/194,104

(22) Filed: Jun. 27, 2016

(30) Foreign Application Priority Data
Jul. 29, 2015 (TW) 104212185

(51) Int. Cl. G08B 13/24

(52) U.S. Cl. CPC G08B 13/2491

(57) ABSTRACT

A wireless motion detecting device and system are disclosed. The wireless motion detecting device comprises a first sensing module, a processing module, a setting module and a communication module. The first sensing module generates a motion signal according to a relative distance between the wireless motion detecting device and the detected object. The processing module generates a warning signal according to the motion signal. The setting module is set up with a relative distance value. The communication module wireless transmits the warning signal.

### BACKGROUND

1. Technical Field

The present disclosure is related to a sensor and system for displacement, especially to detect a relative displacement. Additionally, this present disclosure is a wireless signal transmission device and system.

2. Description of Related Art

Users buy a lot furniture or storage cabinet for their home or office to classify and store things. Some users may need to share the furniture or storage space with other people, and in a commercial context to display some sale items in a showcase. In the less private situation a user's property may be tracked and stolen. These things might happen in a shared living unit or a shared storage space.

### SUMMARY

In view of the foregoing background, it is therefore an object of the present invention to provide a wireless motion detecting device and system. To provide users an effective and simple privacy intrusion detection device.

The instant disclosure provides a wireless motion detecting device, which is used for wireless motion detecting system. The wireless motion detecting device, adapted to detect a detected object, includes a first sensing module, a processing module, a setting module and a communication module. Above-mentioned, the first sensing module is for generating a motion signal according to a relative distance between the wireless motion detecting device and the detected object. The processing module is coupled with the first sensing module, to generate a warning signal based on the motion signal. The setting module is coupling with the processing module, to set up a relative distance value base on the relative distance between the wireless motion detecting device and the detected object. The communication module couples with the processing module, to wirelessly transmit the warning signal.

An embodiment of the instant disclosure provides a wireless motion detecting system. The wireless motion detecting system includes a signal processing device, a detected object and a wireless motion detecting device. The wireless motion detecting device includes a first sensing module, a processing module, a setting module and a communication module. According to a relative distance between the wireless motion detecting device and the detected object, the first sensing module detects a change of the relative distance and correspondingly generates a motion signal. The processing module is coupled with the first sensing module, and generates a warning signal based on the motion signal.

The setting module is coupled with the processing module, to set up a relative distance value based on the relative distance between the wireless motion detecting device and the detected object.

The communication module is coupled with the processing module, and the communication module wirelessly transmits the warning signal generated by the processing module. The signal processing device progressively receives the warning signal which is transmitted by the wireless motion detecting device.

This present disclosure proposes a technique for dynamic motion setting distance and wireless signal transmission through the wireless motion detecting device and system thereof. The present disclosure can allow a user to arbitrarily set up the relative distance between the wireless motion detecting device and the detected object based on demand, or to put the wireless motion detecting device and the detected object which is disposed adjacent to a door, a drawer, a closet, a pocket, a bag, furniture or any other private belongings, in order to know whether the user's private objects are being moved or not, and the warning signal is sent to the user when detecting that the object is moved. The wireless motion detecting device would also scare off intruders when the detected object has been moved. The present disclosure provides a wireless motion detecting device and system which results in a simple design and reduced cost, and can protect privacy in the personal environment more easily.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a functional block schematic diagram of a wireless motion detecting device and a detected object according to an exemplary embodiment of the instant disclosure.

FIG. 2A is a block schematic diagram of a wireless motion detecting system according to an exemplary embodiment of the instant disclosure.

FIG. 2B is a block schematic diagram of a wireless motion detecting system according to another exemplary embodiment of the instant disclosure.

FIG. 3 is a method flowchart diagram of a wireless motion detecting system according to an exemplary embodiment of the instant disclosure.

### DESCRIPTION OF THE EXEMPLARY EMBODIMENTS

Example embodiments will be described below in more detail with reference to the accompanying drawings. Many different forms and embodiments are possible without deviating from the spirit and teachings of this disclosure and so the disclosure should not be construed as limited to the embodiments set forth herein. Rather, these embodiments are provided so that this disclosure will be thorough and complete, and will fully convey the scope of the disclosure to those skilled in the art. In the drawings, the sizes and relative sizes of layers and regions may be exaggerated for clarity. Like reference numbers refer to like elements throughout.

It will be understood that, although the terms first, second, third, and the like, may be used herein to describe various elements, components, regions, layers and/or sections, these elements, components, regions, layers and/or sections should not be limited by these terms. These terms are only to distinguish one element, component, region, layer or section from another region, layer or section discussed below and hence, a first element, component, region, layer or section may be termed as a second element, component, region, layer or section without departing from the teachings of the present disclosure. As used herein, the term “and/or” includes any and all combinations of one or more of the associated listed items.

The following is to describe a wireless motion detecting device via a plurality of embodiments with corresponding drawings. However, the embodiments below are not for restricting the scope of the instant disclosure.

[Embodiment of a Wireless Motion Detecting Device]

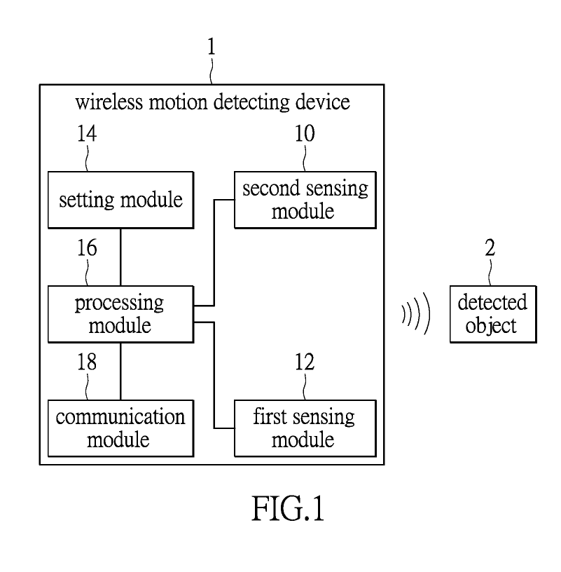

Please refer to FIG. 1, which is a functional block schematic diagram of a wireless motion detecting device and a detected object according to an exemplary embodiment of the instant disclosure. The wireless motion detecting device 1 is for detecting an object 2 and also detecting a changing surrounding environment, to announce to users that either the wireless motion detecting device 1 or the detected object 2 has been moved to a different position or angle by an external force or by the surrounding environment changing.

The wireless motion detecting device 1 includes a first sensing module 12, a second sensing module 10, a setting module 14, a processing module 16 and a communication module 18. The processing module 16 is coupled with the first sensing module 12, the second sensing module 10, the setting module 14 and the communication module 18.

The first sensing module 12 is for detecting a distance between the wireless motion detecting device 1 and the detected object 2. According to a relative distance between the wireless motion detecting device 1 and the detected object 2, the first sensing module 12 generates a relative distance value. Then, the first sensing module 12 generates a motion signal based on the relative distance value change according to a magnetic field. The first sensing module 12 is such as a magnetic sensor and detecting the magnetic field between the wireless motion detecting device 1 and the detected object 2. For example, the first sensing module 12 is a three-axis magnetic sensor for detecting the relative position between the wireless motion detecting device 1 and the detected object 2 in three-dimensional space. The relative distance between the wireless motion detecting device 1 and the detected object 2 is at least 10 meter.

The second sensing module 10 generates an action signal based on an impact or a motion of the wireless motion detecting device 1. The second sensing module 10 is such as a gravity sensor, a vibration sensor or gyroscope and/or a combination of one or more thereof. The second sensing module 10 can provide information of three-dimensional velocity, displacement and/or azimuth change for the wireless motion detecting device 1. For example, the second sensing module 10 also provides velocity information, displacement information, direction change information and/or angle change information when the wireless motion detecting device 1 is in a three-dimensional space.

The processing module 16 receives one of the motion signal from the first sensing module 12 or the action signal from the second sensing module 10. Then the processing module 16 generates a warning signal according to the motion signal or the action signal. Additionally, the setting module 14 sets up a relative distance value base on the relative distance between the wireless motion detecting device 1 and the detected object 2. For example, the setting module 14 can be a button, and a user can push the button to set up the relative distance value base on the relative distance between the wireless motion detecting device 1 and the detected object 2.

The communication module 18 couples with the processing module 16 to receive the warning signal from the processing module 16. The communication module 18 is such as a wireless communication module. Then, the communication module 18 wirelessly transmits the warning signal to a user device to notify the user.

The detected object 2 has a magnetic part which is a powerful magnet or a magnetic object. In this present disclosure, the detected object 2 is miniature housing, a magnetic button, a magnetic sticker or a combination of one or more thereof with magnetism, the above disclosure is not intended to limit the detected object of the present invention. For example, users can put the wireless motion detecting device 1 and the detected object 2 adjacent to a door, a drawer, a closet, a pocket, a bag, furniture or any other accommodating space, and when the wireless motion detecting device 1 or the detected object 2 has been impacted or the position has been changed by an external force, the wireless motion detecting device generates a motion signal. The wireless motion detecting device 1 and the detected object 2 may be set on an accommodating space which can be a pocket, a briefcase, a handbag, a closet or a desk drawers and so on, the equipment set on a desktop, a doorway, or set on either side of a camera to monitor the environment of the detected object 2 to see whether there has been an invasion or not, or whether the position of the detected object 2 has changed in three-dimensional space, such as a position change or change of angle.

When the wireless motion detecting device 1, the detected object 2 and/or a combination of one or both thereof have been moved by any kind of external force, like a position change or change of angle, the wireless motion detecting device 1 generates a warning signal. Then, the wireless motion detecting device 1 wirelessly transmits the warning signal to a user device to notify the user via the communication module 18. And the user may know the wireless motion detecting device 1, the detected object 2 and/or one or both thereof have been impacted or invaded by an external force. This also means containers, drawers, furniture or doors which are nearby the wireless motion detecting device 1 or the detected object 2 might have been impacted by others. The present disclosure is not intended to limit the target number of the warning signal transmitted by the setting module 14.

Additionally, the wireless motion detecting device is an independent device; with a power source from a built-in battery. Thus, the motion detecting device 1 and the detected object 2 can be put anywhere without having to use external electrical connection.

[Embodiment of a Wireless Motion Detecting System]

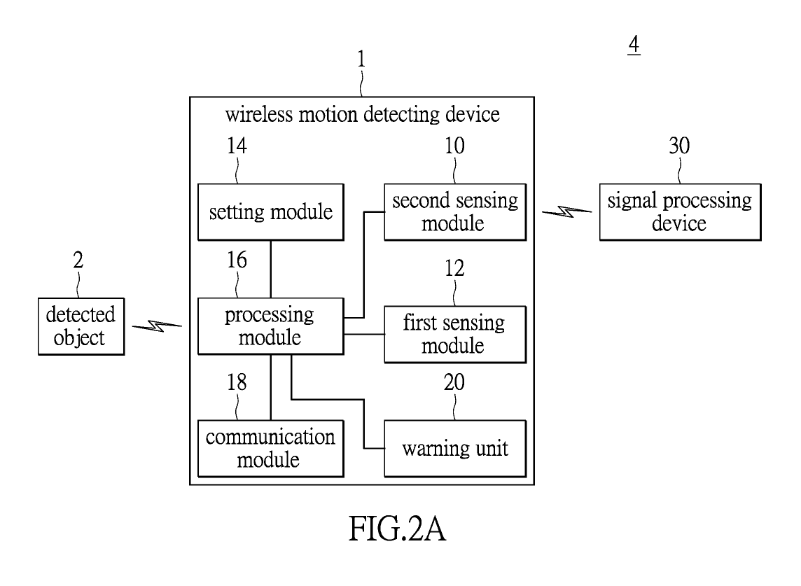

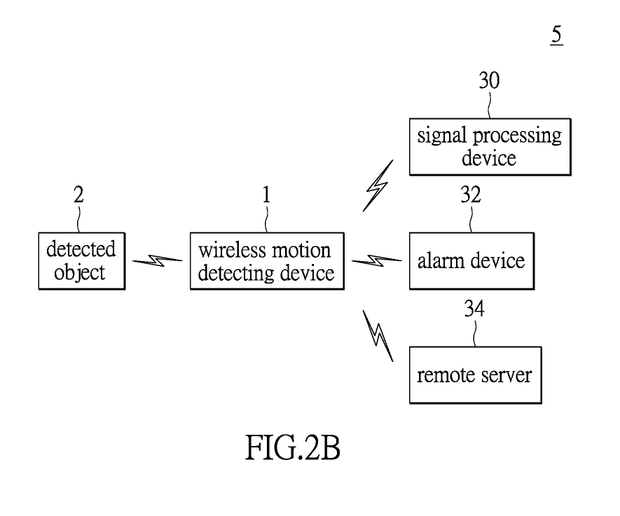

FIG. 2A is a block schematic diagram of a wireless motion detecting system according to an exemplary embodiment of the instant disclosure. As shown in FIG. 2A, the wireless motion detecting system 4 includes a wireless motion detecting device 1, a detected object 2 and a signal processing device 3. The wireless motion detecting device 1 includes a first sensing module 12, a second sensing module 10, a setting module 14, a processing module 16, a communication module 18 and a warning unit 20. The first sensing module 12, the second sensing module 10, the setting module 14, the processing module 16, and the communication module 18 are the same as above-mentioned disclosure. In the following embodiments, only parts different from embodiments in FIG. 1 are described, and the omitted parts are indicated to be identical to the embodiments in FIG. 1. In addition, for easy instruction, similar reference numbers or symbols refer to the same elements.

It is worth to mention that the wireless motion detection device 1 also includes a warning unit 20, and the warning unit 20 is coupled with the processing module 16. When the processing module 16 generates the warning signal, the warning unit 20 correspondingly generates an alert signal. Regarding to the warning unit 20, the warning unit 20 is such as a light-emitting diode bulb or a low-power buzzer. For example, the warning unit 20 can be a multi-colored switching light-emitting diode bulb. And the wireless motion detecting device 1 and the detected object 2 can be disposed adjacent at a window frame and a window. The warning unit 20 displays a green light when a user presses the setting module 14 to set up a relative distance value based on the relative distance between the wireless motion detecting device 1 and the detected object 2, and thereby the relative distance value between the wireless motion detecting device 1 and the detected object 2 is regarded as setting completed. Then, the warning unit 20 displays a red light when the relative distance between the wireless motion detecting device 1 and the detected object 2 has been changed by an external force. The above disclosure is not intended to limit the warning unit of the present invention.

In an embodiment of the instant disclosure, the signal processing device 3 receives the warning signal which is transmitted by the wireless motion detecting device to notify users whether the relative distance value between the wireless motion detecting device 1 and the detected object 2 has been changed by an external force or not. Regarding the signal processing device 20, the signal processing device 20 is such as a portable smart phone or a smart tablet. Taking the signal processing device 20 as a portable electronic products as an example, the portable electronic products can receive the warning signal which is transmitted by the wireless motion detecting device 1 via the communication module 18. Then, the portable electronic product displays warning information on the screen. Thereby, users can know whether a change in the situation of the users' private objects or the users' private space has been detected and the space has been invaded or not.

FIG. 2B is a block schematic diagram of a wireless motion detecting system according to another exemplary embodiment of the instant disclosure. Please refer to FIG. 2B, the wireless motion detecting system 5 comprises a wireless motion detecting device 1, a detected object 2, a signal processing device 30, an alarm device 32 and a remote server 34.

In an embodiment of the wireless motion detecting system 5 of the instant disclosure, the alarm device 32 is such as a buzzer or a speaker. The wireless motion detecting device 1 transmits the warning signal to the alarm device 32. Then, the alarm device 32 makes a warning sound. The above disclosure is not intended to limit the alarm device of the present invention. For example, the alarm device 32 can be disposed in the same room as the wireless motion detecting device 1, or disposed in any other place so it can notify users.

In an embodiment of the instant disclosure, the wireless motion detect device 1 is disposed at a door frame of a room, the detected object 2 is correspondingly disposed at door handle of the room, and the alarm device 32 is provided in the room. Generally, the wireless motion detect device 1 and the detected object 2 are in a stationary state, and the wireless motion detect device 1 will not generate any signals. Then, if anyone tries to open the door, a first sensing module 12 of the wireless motion detecting device 1 detects a difference and communicates with the alarm device 23 in the room, because a relative distance value between the wireless motion detecting device 1 and the detected object 2 has been changed. Thereby, the alarm device 32 makes an audible alarm.

In another embodiment, if there is anyone who tries to break the lock of the door to enter the room, a second sensing module 10 of the wireless motion detecting device 1 will detect the abnormal vibration, and sense the change of motion. The alarm device 32 also makes an audible alarm.

[Another Embodiment of a Wireless Motion Detecting Method]

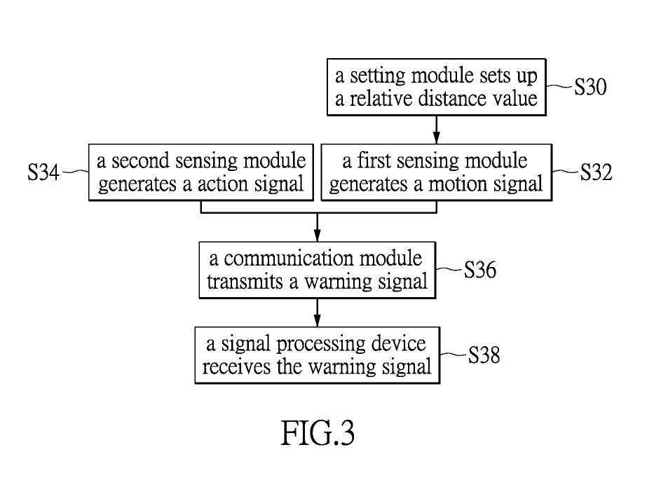

FIG. 3 is a method flowchart diagram of a wireless motion detecting system according to an exemplary embodiment of the instant disclosure. Please refer to FIG. 2A, FIG. 2B and FIG. 3. Firstly, in step S30, a setting module 14 of a wireless motion detecting device 1 set up according to a relative distance value based on a relative distance between the wireless motion detecting device 1 and the detected object 2. Then, in step S32, a first sensing module 12 of the wireless motion detecting device 1 generates a motion signal when sensing a change of the relative distance value; or, in step S34, a second sensing module 10 of the wireless motion detecting device 1 generates an action signal when sensing an external force movement or an impact. Then a processing module 16 of the wireless motion detecting device 1 generates the warning signal when sensing the motion signal or the action signal. In step S36, a communication module 18 of the wireless motion detecting device 1 transmits the warning signal. Afterward, in step S38, a signal processing device 3 receives the warning signal.

To sum up, the instant disclosure provides a wireless motion detecting device corresponding to a detected object to detect whether a relationship of the wireless motion detecting device and the detected object whether been changed or impacted. A change of position generates a motion signal or an action signal. Then, a processing module generates a warning signal based on the motion signal or the action signal. The wireless motion detecting device transmits the warning signal to a signal processing device by a communication module. Therefore, user can put the wireless motion detecting device and the detected object at any private places in any container, to find out whether anyone without permission has touched personal belongings or intruded the personal space. On the other hand, the instant disclosure provides that the wireless motion detecting device can be hid in any covering discretely, and also the detected object can be miniaturized. The instant disclosure increases the hidden feature of the wireless motion detecting device, to lower other people's awareness. Also, it can create a respective warning signal for a small area more perfectly.

The instant disclosure can be implemented in any suitable form including hardware, software, firmware or any combination of these. The invention may optionally be implemented partly as computer software running on one or more data processors and/or digital signal processors. The units and components of an embodiment of the invention may be physically, functionally and logically implemented in any suitable way. Indeed a certain functionality may be implemented in a single unit, in a plurality of units or as part of other functional units. As such, the invention may be implemented in a single unit or may be physically and functionally distributed between different units and processors.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A wireless motion detecting device, adapted to detect an object, comprising:
a first sensing module, the first sensing module for generating a motion signal according to a relative distance between the wireless motion detecting device and the detected object;
a processing module, the processing module, coupling with the first sensing module, to generate a warning signal according to the motion signal;
a setting module, the setting module connected to the processing module, and set up a relative distance value based on the relative distance between the wireless motion detecting device and the detected object; and
a communication module, the communication module connected to the processing module, to wirelessly transmit the warning signal.

2. The wireless motion detecting device according to claim 1, wherein the first sensing module is a magnetic sensor.

3. The wireless motion detecting device according to claim 2, wherein the magnetic sensor is a three-axis magnetic sensor.

4. The wireless motion detecting device according to claim 1, further comprising a warning unit, the warning unit connected to the processing module, wherein when the processing module generates the warning signal, and the warning unit generates an alert signal.

5. The wireless motion detecting device according to claim 1, further comprising a second sensing module, the second sensing module connected to the processing module, to generate a motion signal to the processing module based on an impact or motion of the wireless motion detecting device, then the processing module generates the warning signal according to the motion signal, wherein the second sensing module comprising a gravity sensor, vibration sensors or gyroscope and/or a combination of one or more thereof.

6. The wireless motion detecting device according to claim 1, wherein the communication module wirelessly transmits the warning signal to a mobile electronic device, a remote server and/or a combination of one or more thereof.

7. The wireless motion detecting device according to claim 1, wherein the wireless motion detecting device and the detected object are disposed adjacent to a door, a drawer, a closet, a pocket, a bag or furniture.

8. The wireless motion detecting device according to claim 1, wherein the detected object comprises a magnetic part.

9. A wireless motion detecting system, comprising:
a signal processing device;
a detected object; and
a wireless motion detecting device, comprising:
a first sensing module, the first sensing module for generating a motion signal according to a relative distance between the wireless motion detecting device and the detected object;
a processing module, the processing module, coupling with the first sensing module, and generating a warning signal according to the motion signal;
a setting module, the setting module connected to the processing module, to set up a relative distance value based on the relative distance between the wireless motion detecting device and the detected object; and
a communication module, the communication module connected to the processing module, to wirelessly transmit the warning signal;
wherein the signal processing device receives the warning signal which is transmitted by the wireless motion detecting device.

10. The wireless motion detecting system according to claim 9, wherein the wireless motion detecting device further comprising a second sensing module, the second sensing module connected to the processing module, generating an motion signal to the processing module based on impact or motion of the wireless motion detecting device, then the processing module generating the warning signal according to the motion signal, and the signal processing device comprising a mobile electronic device to receive the warning signal from the wireless motion detecting device.
